(19) United States
(12) Patent Application Publication
(10) Pub. No.: US 2019/0087611 A1
(43) Pub. Date: Mar. 21, 2019

(54) MAGNETIC HEAD AND CARD READER

(71) Applicant: NIDEC SANKYO CORPORATION, Suwa-gun Nagano (JP)

(72) Inventors: Yukihiko TAKITA, Suwa-gun Nagano (JP); Masaya FUJIMOTO, Suwa-gun Nagano (JP)

(21) Appl. No.: 16/088,274

(22) PCT Filed: Mar. 8, 2017
(86) PCT No.: PCT/JP2017/009307

§ 371 Date: Sep. 25, 2018

(30) Foreign Application Priority Data
Mar. 25, 2016 (JP) 2016-061519

(51) Int. Cl. G06K 7/08

(52) U.S. Cl. CPC G06K 7/087

(57) ABSTRACT

A magnetic head to detect a change of a magnetic field caused by a passing of a magnetic recording medium may include a head main body including a core provided with a gap and a coil which is wound around the core; a demodulation circuit structured to demodulate an analog signal outputted from the coil; an encryption circuit structured to encrypt a demodulated signal outputted from the demodulation circuit; a head case in which the head main body is accommodated; and a filter circuit which is connected between the coil and the demodulation circuit and is structured to remove noise from the analog signal. An electronic component which structures the filter circuit may be accommodated in the head case.

### TECHNICAL FIELD

At least an embodiment of the present invention relates to a magnetic head structured to detect a change in a magnetic field when a magnetic recording medium such as a magnetic card has been passed. Further, at least an embodiment of the present invention relates to a card reader structured to read magnetic information recorded in a magnetic track of a magnetic card by the magnetic head.

### BACKGROUND

A card reader structured to read magnetic information from a magnetic card having a magnetic track is described in Patent Literature 1. In the card reader described in the Patent Literature, a magnetic head includes a core having a gap, a coil wound around the core, a demodulation circuit structured to demodulate an analog signal outputted from the coil, and an encryption circuit structured to encrypt a demodulated signal outputted from the demodulation circuit. The magnetic head detects a change in a magnetic field when a magnetic card is passed through the gap and outputs an encrypted signal from the encryption circuit.

### PATENT LITERATURE

[PTL 1] Japanese Patent Laid-Open No. 2011-40140

In some card readers, a magnetic card is manually moved along a movement path through a reading position by a magnetic head and magnetic information is read. In the card reader, noise caused by minute vibration occurred when a magnetic card is moved along the movement path may be superimposed on an analog signal outputted from the coil. Further, in some card readers, a magnetic card is conveyed along a conveyance path through a reading position by a magnetic head to read magnetic information by using a conveyance mechanism whose drive source is a motor. In the card reader, a magnetic field generated by the motor and the like may be superimposed on an analog signal outputted from the coil as noise. When noise is superimposed on an analog signal outputted from the coil, reading accuracy of magnetic information which is read from a magnetic track by a card reader is deteriorated.

In this case, in a magnetic head in which an analog signal outputted from a coil is demodulated and then encrypted, even when a filter circuit for removing noise is provided for an output from the magnetic head, the noise superimposed on the analog signal cannot be removed.

### SUMMARY

In view of the problem described above, at least an embodiment of the present invention provides a magnetic head and a card reader capable of restraining deterioration of reading accuracy caused by noise even when magnetic information of a card can be prevented from being illegally acquired.

To solve the above-mentioned problem, at least an embodiment of the present invention provides a magnetic head including a head main body having a core provided with a gap and a coil which is wound around the core, a demodulation circuit structured to demodulate an analog signal outputted from the coil, an encryption circuit structured to encrypt a demodulated signal outputted from the demodulation circuit, and a head case in which the head main body is accommodated. The magnetic head is structured so that a change of a magnetic field when a magnetic recording medium is passed through the gap is detected, and the magnetic head further includes a filter circuit which is connected between the coil and the demodulation circuit and is structured to remove noise from the analog signal, and an electronic component which structures the filter circuit is accommodated in the head case.

According to at least an embodiment of the present invention, the magnetic head includes a filter circuit in an inside of the head case. Therefore, even when noise is superimposed on an analog signal outputted from the coil, influence of noise is prevented or restrained from being left in a signal outputted from the magnetic head. Accordingly, when magnetic information has been read by using the magnetic head, deterioration of reading accuracy caused by noise can be prevented or restrained. Further, the magnetic head includes a filter circuit in the inside of the head case and thus, even in a magnetic head in which an analog signal is demodulated and then encrypted and outputted, influence of noise is restrained from being left in an output from the magnetic head. Therefore, according to the magnetic head in at least an embodiment of the present invention, even when magnetic information can be prevented from being illegally acquired, deterioration of reading accuracy caused by noise is capable of being restrained.

In at least an embodiment of the present invention, the magnetic head further includes a circuit board provided with a wiring pattern for the filter circuit and on which the electronic component is mounted, and the circuit board is accommodated in the head case. In a case that a plurality of electronic components structures the filter circuit, when these electronic components are mounted on the circuit board, they can be arranged compactly. Therefore, when a circuit board is provided, the filter circuit is easily accommodated in the head case.

In at least an embodiment of the present invention, the head main body includes a first terminal which is connected with one end of the coil and a second terminal which is connected with the other end of the coil and is extended in parallel to and separated from the first terminal, and the circuit board is laid across the first terminal and the second terminal. According to this structure, the circuit board can be supported by the head main body. Therefore, the circuit board is easily accommodated in the head case together with the head main body.

In at least an embodiment of the present invention, a plurality of the head main bodies is provided as the head main body, which are arranged in a direction intersecting a passing direction in which the magnetic recording medium is passed, a plurality of the circuit boards is provided as the circuit board, each of which is laid across the first terminal and the second terminal of each of the head main bodies, and a shield plate is inserted between the head main bodies adjacent to each other. According to this structure, the magnetic head is structured so as to provide with magnetic reading channels corresponding to the number of the head main bodies. Further, a shield plate is provided between the respective head main bodies and thus a magnetic field generated by one of the head main bodies adjacent to each other can be prevented from affecting the other of the head main bodies as noise. In addition, each of the circuit boards is extended between the first terminal and the second terminal of each of the head main bodies and thus, when a shield plate is inserted between the head main bodies adjacent to each other, insertion of the shield plate is not obstructed by the circuit board and the magnetic head is easily assembled.

In at least an embodiment of the present invention, resin is filled in an inside of the head case. According to this structure, a plurality of the head main bodies and a plurality of the circuit boards can be fixed in the inside of the head case. Further, the filter circuits for removing noise from an analog signal outputted from the respective coils are respectively structured on three circuit boards divided to the respective head main bodies instead of collectively structuring on one circuit board and thus resin is easily filled in an inside of the head case without leaving a space.

In at least an embodiment of the present invention, the magnetic head further includes a second circuit board which is provided with the demodulation circuit on one circuit board face and the encryption circuit on the other circuit board face, the head case is provided with an opening part for inserting the head main body into the head case, the second circuit board is fixed to the head case so that the opening part is closed in a state that the one circuit board face is directed toward a side of the head case, and the demodulation circuit is disposed in an inside of the head case. According to this structure, the opening part of the head case can be closed by the second circuit board.

Next, at least an embodiment of the present invention provides a card reader including a magnetic head including a head main body having a core provided with a gap and a coil which is wound around the core, a demodulation circuit structured to demodulate an analog signal outputted from the coil, an encryption circuit structured to encrypt a demodulated signal outputted from the demodulation circuit, and a head case in which the head main body is accommodated, and a path where a magnetic card having a magnetic track is moved so as to pass the gap of the magnetic head. The magnetic head further includes a filter circuit which is connected between the coil and the demodulation circuit and is structured to remove noise from the analog signal, and an electronic component structuring the filter circuit is accommodated in the head case.

According to at least an embodiment of the present invention, the magnetic head includes a filter circuit in an inside of a head case. Therefore, in a case that a magnetic track of a magnetic card is read by the magnetic head, even when noise is superimposed on an analog signal outputted from the coil, influence of noise is prevented or restrained from being left in a signal outputted from the magnetic head. Accordingly, reading accuracy for a magnetic track by the card reader is improved. Further, the magnetic head includes the filter circuit in the inside of the head case and thus, even in a magnetic head in which an analog signal is demodulated and then encrypted and outputted, influence of noise is restrained from being left in an output from the magnetic head. Therefore, according to the card reader in at least an embodiment of the present invention, even when magnetic information can be prevented from being illegally acquired, deterioration of reading accuracy caused by noise is capable of being restrained.

According to at least an embodiment of the present invention, the magnetic head includes a filter circuit in an inside of the head case. Therefore, when magnetic information has been read by the magnetic head, even in a case that noise is superimposed on an analog signal outputted from the coil, influence of noise is prevented or restrained from being left in a signal outputted from the magnetic head. Further, the magnetic head includes the filter circuit in the inside of the head case and thus, even in a magnetic head in which an analog signal is demodulated and then encrypted and outputted, influence of noise is restrained from being left in an output from the magnetic head.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1A and FIG. 1B are an explanatory view showing a card reader in accordance with an embodiment of the present invention and an explanatory view showing a magnetic card.

FIG. 2A and FIG. 2B are perspective views showing a magnetic head which is mounted on the card reader in FIG. 1A.

FIG. 3A and FIG. 3B are cross-sectional views showing the magnetic head in FIG. 2A.

FIG. 4A and FIG. 4B are perspective views showing the magnetic head in which a control circuit board is not shown.

FIG. 5 is a block diagram showing a signal processing system in the magnetic head.

### DETAILED DESCRIPTION

A magnetic head in accordance with an embodiment of the present invention and a card reader mounting the magnetic head will be described below with reference to the accompanying drawings.

### Entire Structure

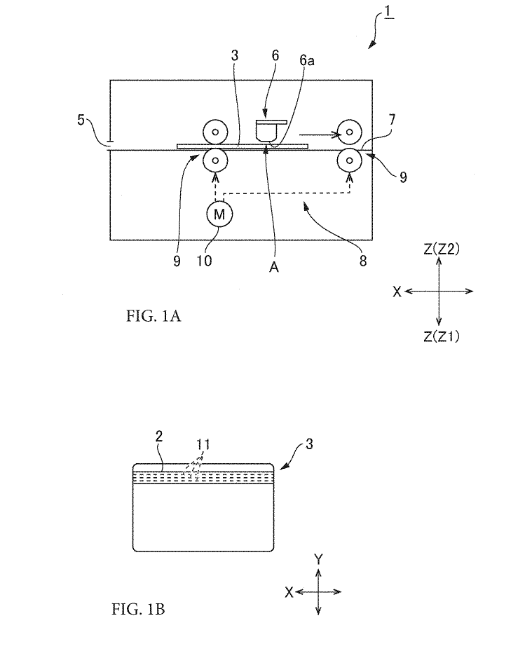

FIG. 1A is an explanatory view showing a card reader in accordance with an embodiment of the present invention, and FIG. 1B is an explanatory view showing a magnetic card whose magnetic information is read by a card reader. A card reader 1 in this embodiment reads a magnetic card (magnetic recording medium) 3 provided with a magnetic stripe 2 and acquires magnetic information recorded in the magnetic stripe 2. The card reader 1 includes a card insertion port 5, a magnetic head 6, a card conveyance path 7 which is extended from the card insertion port 5 so as to pass a reading position “A” by the magnetic head 6, and a conveyance mechanism 8 structured to convey a magnetic card 3 inserted into the card insertion port 5 along the card conveyance path 7. The magnetic head 6 is disposed so that its sensor face 6a is directed toward a side of the card conveyance path 7. The conveyance mechanism 8 includes two conveying roller pairs 9 structured to sandwich a magnetic card 3 therebetween and convey it. The respective conveying roller pairs 9 are respectively disposed on an upstream side and a downstream side with respect to the reading position “A”. Further, the conveyance mechanism 8 includes a conveyance motor 10 as a drive source for the conveying roller pairs 9.

The card reader 1 drives the conveyance motor 10 and operates the conveyance mechanism 8 when a magnetic card 3 is inserted into the card insertion port 5. As a result, the magnetic card 3 is conveyed along the card conveyance path 7 and is passed through the reading position “A”. When the magnetic card 3 is passed through the reading position “A”, the magnetic stripe 2 slides on the sensor face 6a of the magnetic head 6. Therefore, the magnetic head 6 detects a change in a magnetic field when the magnetic card 3 is passed through the head face 6a and outputs magnetic information held in the magnetic card 3. The magnetic information outputted from the magnetic head 6 is encrypted.

### Magnetic Head

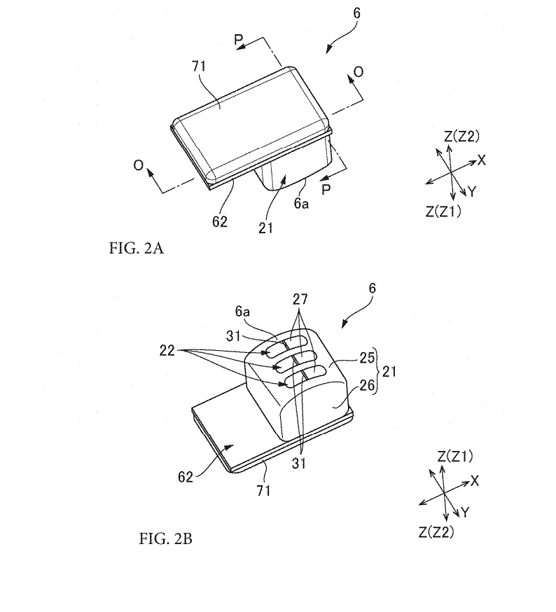

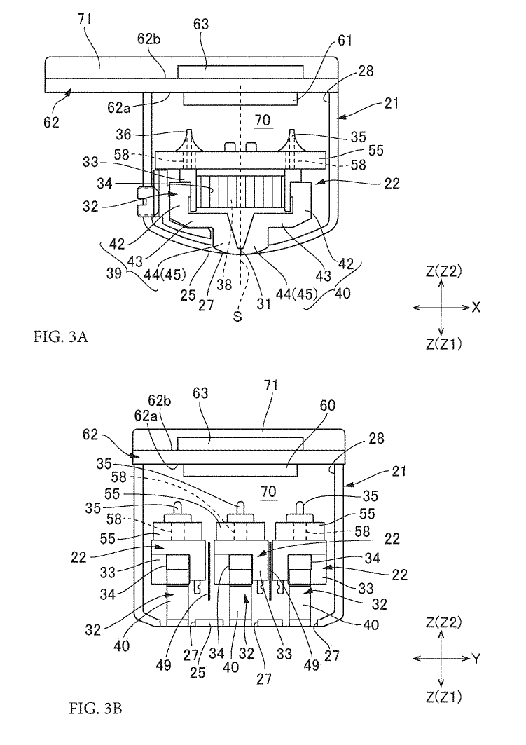

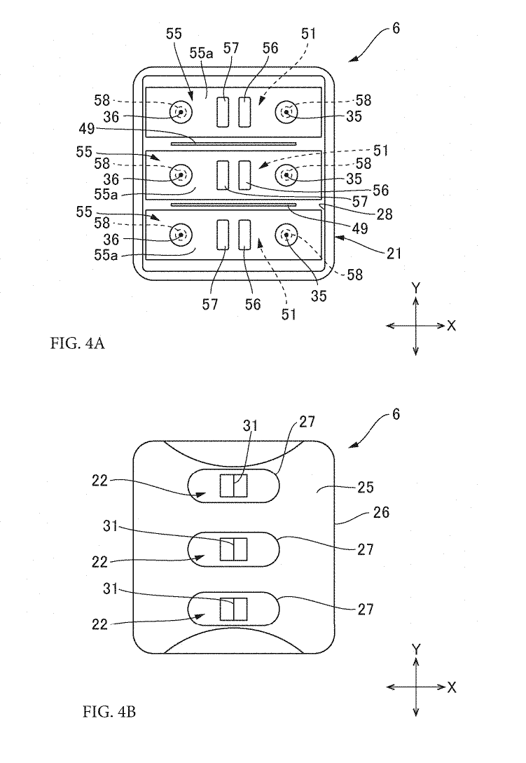

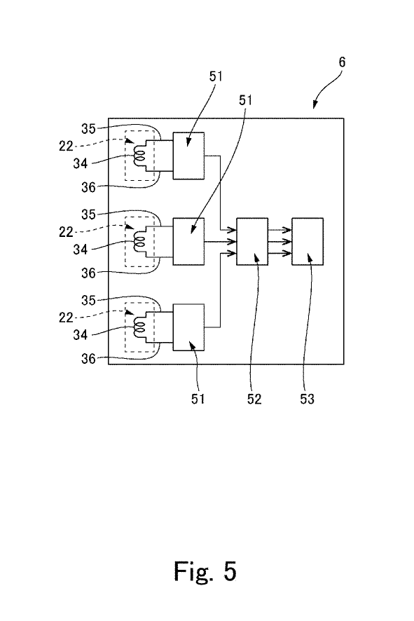

FIG. 2A is a perspective view showing the magnetic head 6 which is viewed from an opposite side to the sensor face 6a, and FIG. 2B is a perspective view showing the magnetic head 6 which is viewed from a side of the sensor face 6a. FIG. 3A is a cross-sectional view showing the magnetic head 6 by the “O-O” line in FIG. 2A, and FIG. 3B is a cross-sectional view showing the magnetic head 6 by the “P-P” line in FIG. 2A. FIG. 4A is a plan view showing the magnetic head 6 in which a control circuit board mounted with a demodulation circuit and an encryption circuit is detached and which is viewed from an opposite side to the sensor face 6a, and FIG. 4B is a plan view showing the magnetic head 6 in which the control circuit board mounted with the demodulation circuit and the encryption circuit is detached and which is viewed from a side of the sensor face 6a. FIG. 5 is a block diagram showing a signal processing system in the magnetic head.

In the following descriptions, a posture that the sensor face 6a of the magnetic head 6 is directed downward as shown in FIG. 1A is a reference posture of the magnetic head 6, and an upper and lower direction in the reference posture is an upper and lower direction “Z” of the magnetic head 6. Further, a direction perpendicular to the upper and lower direction “Z”, which is a passing direction of a magnetic card 3 conveyed in the card conveyance path 7 and passed through the sensor face 6a of the magnetic head 6 is referred to as a front and rear direction “X” of the magnetic head 6. In addition, a direction perpendicular to the upper and lower direction “Z” and the front and rear direction “X” (passing direction of a magnetic card 3) is referred to as a width direction (direction intersecting the passing direction) “Y” of the magnetic head 6.

The magnetic head 6 is a three channel-type magnetic head which is structured to read three magnetic tracks 11 (see FIG. 1B) formed in a magnetic stripe 2 of a magnetic card 3. As shown in FIG. 2B and FIG. 3B, the magnetic head 6 includes a head case 21 and three head main bodies 22 structured to read magnetic information from respective magnetic tracks 11.

The head case 21 is made of soft magnetic material such as Permalloy. As shown in FIG. 2B, the head case 21 is provided with a rectangular bottom plate portion 25 which defines the sensor face 6a and a rectangular tube portion 26 which is extended to an upper side “Z2” from an outer circumferential edge of the bottom plate portion 25. The bottom plate portion 25 is formed in a curved shape so that its center portion in the front and rear direction “X” is protruded to an outer side. A center portion in the front and rear direction “X” of the bottom plate portion 25 is provided with three sensor face opening parts 27. Three sensor face opening parts 27 are elongated holes which are extended in the front and rear direction “X” and are arranged in the width direction “Y”. As shown in FIG. 3A and FIG. 3B, an end of the rectangular tube portion 26 on an opposite side (upper end) to the bottom plate portion 25 is formed to be an opening part 28 for inserting three head main bodies 22 into the head case 21.

As shown in FIG. 3A, each of the head main bodies 22 includes a core 32 having a gap 31, a coil 34 which is wound around the core 32 through a coil bobbin 33, a first terminal 35 which is connected with one end of the coil 34, and a second terminal 36 which is connected to the other end of the coil 34.

The core 32 is provided with a wound portion 38 around which the coil 34 is wound through the coil bobbin 33. The wound portion 38 is formed in a bar shape and is provided with a rectangular cross-sectional shape. The wound portion 38 is extended in the front and rear direction “X”. Further, the core 32 is, as shown in FIG. 3A, provided with a first arm portion 39 which is arranged so as to protrude toward a lower side “Z1” (side of the sensor face 6a) from an end part of the wound portion 38 on one side in the front and rear direction “X”, and a second arm portion 40 which is arranged so as to protrude toward the lower side “Z1” from an end part on the other side in the front and rear direction “X”.

The first arm portion 39 is provided with a first extended part 42 extended from the end part on the one side of the wound portion 38 to the lower side “Z1”, a second extended part 43 extended from a lower end part of the first extended part 42 to the other side in the front and rear direction “X”, and a third extended part 44 extended from an end part on the other side of the second extended part 43 to the lower side “Z1”. The second arm portion 40 is provided with a first extended part 42 extended from an end part on the other side of the wound portion 38 to the lower side “Z1”, a second extended part 43 extended from a lower end part of the first extended part 42 to the one side in the front and rear direction “X”, and a third extended part 44 extended from an end part on the one side of the second extended part 43 to the lower side “Z1”. In this case, a lower end part of the third extended part 44 of the first arm portion 39 and a lower end part of the third extended part 44 of the second arm portion 40 structure facing parts 45 which face each other in a separated state through the gap 31 in the front and rear direction “X”. Further, the first arm portion 39 and the second arm portion 40 are provided with a symmetrical shape with respect to an imaginary face “S” which is extended from a center in the front and rear direction “X” of the gap 31 toward the upper and lower direction “Z” and the width direction “Y”.

A center axial line of the coil 34 is directed in the front and rear direction “X”. The first terminal 35 and the second terminal 36 are respectively fixed to both end portions in the front and rear direction “X” of the coil bobbin 33 in the front and rear direction “X”. The first terminal 35 and the second terminal 36 are extended in parallel to each other toward an upper side “Z2” (opposite side to the sensor face 6a).

Three head main bodies 22 are, as shown in FIG. 3B, arranged in the width direction “Y” and accommodated in the head case 21. Therefore, the gaps 31 of the respective head main bodies 22 are exposed to an outer side of the head case 21 from the sensor face opening part 27 provided in the bottom plate portion 25 of the head case 21 (see FIG. 2B and FIG. 4B). In this embodiment, a shield plate 49 is disposed between the head main bodies 22 adjacent to each other in the width direction “Y”. The shield plate 49 is a flat plate made of soft magnetic material such as Permalloy. The shield plate 49 is enlarged in the front and rear direction “X” and the upper and lower direction “Z” in a state that its thickness direction is directed to the width direction “Y”.

Next, the magnetic head 6 includes, as shown in FIG. 5, filter circuits 51 each of which removes noise from an analog signal outputted from the first terminal 35 and the second terminal 36 of each of the head main bodies 22, a demodulation circuit 52 which demodulates noise-removed analog signals outputted from the filter circuits 51, and an encryption circuit 53 which encrypts demodulated signals outputted from the demodulation circuit 52. The encrypted signals which are outputted from the magnetic head 6 are outputted from the encryption circuit 53.

The filter circuits 51 are provided for every channel. In other words, the magnetic head 6 includes, as the filter circuit 51, three filter circuits 51 each of which removes noise from an analog signal outputted from the first terminal 35 and the second terminal 36 of each of the head main bodies 22. As shown in FIG. 4A, each filter circuit 51 is structured in each circuit board 55 which is attached and extended between the first terminal 35 and the second terminal 36 of each head main body 22. In this embodiment, the filter circuit 51 removes another frequency band as noise other than a frequency band which is required to acquire magnetic information from an analog signal outputted from the first terminal 35 and the second terminal 36. Further, a frequency component of magnetic information and a moving speed of a magnetic card 3 which is moved by the conveyance mechanism 8 can be grasped in advance and thus another frequency band which is to be removed as noise can be grasped in advance on the basis of the frequency component and the moving speed.

A circuit board face 55a on an upper side of each of the circuit boards 55 is formed with a wiring pattern (not shown) for the filter circuit, and a capacitor 56 and a resistor 57 structuring the filter circuit 51 (a plurality of electronic components) are mounted. Each of the circuit boards 55 is a rectangular circuit board whose longitudinal direction is set in the front and rear direction “X”, and a through hole 58 is provided at both end portions in the longitudinal direction. Further, the circuit board 55 is attached to the first terminal 35 and the second terminal 36 in a state that the first terminal 35 and the second terminal 36 are penetrated through the respective through holes 58. Each of the first terminal 35 and the second terminal 36 which are penetrated through the through holes is soldered to a land of a wiring pattern provided around the through hole 58 on the circuit board face 55a. In this embodiment, a width of each of the circuit boards 55 is the same or slightly narrower than a width of each of the head main bodies 22. Further, when viewed in the upper and lower direction “Z”, the head main body 22 and the circuit board 55 laid across the first terminal 35 and the second terminal 36 of the head main body 22 are overlapped with each other.

The demodulation circuit 52 demodulates noise-removed analog signals outputted from the respective filter circuits 51 and outputs digital demodulated signals. As shown in FIG. 3A and FIG. 3B, the demodulation circuit 52 includes a demodulation IC 61. The demodulation IC 61 is mounted on a circuit board face (first circuit board face) 62a on a lower side of the control circuit board 62. The encryption circuit 53 encrypts the demodulated signal by a predetermined encryption function and key data to output an encrypted signal. The encryption circuit 53 includes a CPU 63. The CPU 63 is mounted on a circuit board face 62b on an upper side of the control circuit board 62. In this embodiment, each filter circuit 51 (each circuit board 55) and the demodulation circuit 52 (control circuit board 62) are connected with each other through a flexible printed circuit board not shown.

The control circuit board 62 is fixed to the rectangular tube portion 26 of the head case 21 and covers the opening part 28 from the upper side “Z2”. Therefore, the demodulation circuit 52 is disposed in an inside of the head case 21. In this embodiment, resin 70 is filled in the head case 21. The resin 70 is epoxy resin and the resin fixes the control circuit board 62 to the head case 21. Further, the entire CPU 63 on the circuit board face 62b on the upper side of the control circuit board 62 is sealed with resin 71. The resin 71 is epoxy resin.

### Assembling of Magnetic Head

In order to assemble the magnetic head 6, first, the circuit board 55 on which the capacitor 56 and the resistor 57 are mounted is laid across the first terminal 35 and the second terminal 36 of the head main body 22. Then, the head main body 22 and the circuit board 55 are integrated with each other. Next, the head case 21 is set in a posture that the sensor face 6a faces the lower side “Z1”.

After that, three sets of a pair of the head main body 22 and the circuit board 55 integrated with each other are inserted into the head case 21 from the opening part 28. Further, the pairs of the head main body 22 and the circuit board 55 integrated with each other are arranged within the head case 21 in the width direction “Y”. After that, a shield plate 49 is inserted between the circuit boards 55 adjacent to each other from the upper side “Z2” and each of the shield plates 49 inserted is located between the head main bodies 22 adjacent to each other. As a result, a state shown in FIG. 4A is formed.

Next, the control circuit board 62 including the demodulation circuit 52 and the encryption circuit 53 and the respective circuit boards 55 are connected with each other through a flexible printed circuit board not shown. After that, resin is filled in the head case 21 through the opening part 28. Further, the circuit board face 62a on which the demodulation IC 61 of the demodulation circuit 52 is mounted is directed toward the lower side “Z1”, the demodulation IC 61 is inserted into the head case 21 from the opening part 28, and the opening part 28 is covered by the control circuit board 62. As a result, the control circuit board 62 is fixed to an opening edge of the head case 21 by the resin 70 filled in the head case 21. After that, an upper face of the control circuit board 62 is covered with the resin 71 to seal the CPU 63 of the encryption circuit 53. In this manner, the magnetic head 6 is completed.

In this embodiment, the circuit board 55 including the filter circuit 51 is laid across the first terminal 35 and the second terminal 36 of the head main body 22 and is integrated with the head main body 22. Therefore, the circuit board 55 is easily accommodated into the head case 21 together with the head main body 22.

In this case, it may be structured that the filter circuits 51 for removing noise from analog signals outputted from the respective coils 34 of the respective head main bodies 22 are collectively structured on one piece of a circuit board. However, in this embodiment, the filter circuit 51 for each channel is structured in each of three divided circuit boards 55. Further, a width of each of the divided circuit boards 55 is equal to or less than a width of the head main body 22 and, when viewed in the upper and lower direction “Z”, the head main body 22 and the circuit board 55 are overlapped with each other. Therefore, when the shield plate 49 is to be inserted between the head main bodies 22 adjacent to each other, the circuit board 55 does not obstruct insertion of the shield plate 49 and thus the magnetic head 6 is easily assembled.

### Operations and Effects

According to the card reader 1 in this embodiment, the magnetic head 6 includes the filter circuit 51 in the inside of the head case 21. Therefore, even when noise is superimposed on an analog signal outputted from the coil 34, influence of noise is prevented or restrained from being left in a signal outputted from the magnetic head 6. Therefore, reading accuracy for a magnetic track 11 by the card reader 1 is improved. Further, the magnetic head 6 includes the filter circuit 51 in the inside of the head case 21 and thus, also in the magnetic head 6 in which an analog signal is demodulated and then encrypted and outputted, noise superimposed on the analog signal can be removed.

Further, in this embodiment, the capacitor 56 and the resistor 57 structuring the filter circuit 51 are mounted on the circuit board 55 and accommodated in the head case 21. In a case that a plurality of electronic components structures a circuit, when the electronic components are mounted on the circuit board 55, they can be arranged compactly. Therefore, the filter circuit 51 can be accommodated in the inside of the head case 21. Further, the size of the magnetic head 6 in which the filter circuit 51 is accommodated in the inside of the head case 21 can be reduced.

In addition, in this embodiment, the shield plate 49 is provided between the respective head main bodies 22. Therefore, a magnetic field generated from one of the head main bodies 22 adjacent to each other can be prevented from affecting the other of the head main bodies 22 as noise.

### Other Embodiments

In the embodiment described above, the filter circuits 51 for respective channels are respectively structured in different circuit boards 55. However, the filter circuits 51 may be structured on one piece of a circuit board. Further, the electronic components which structure the filter circuit 51 are mounted on the circuit board 55. However, it may be structured that the electronic components are directly connected with each other to structure the filter circuit 51 without using the circuit board 55 and that the filter circuit 51 is directly connected with each coil 34 (first terminal 35 and second terminal 36) of each of the head main bodies 22.

Further, the card reader may be structured so that a magnetic card 3 is manually moved along a guide groove (path) passing through a reading position “A” by the magnetic head 6 without providing the conveyance mechanism 8. In this card reader, noise caused by a minute vibration of a magnetic card occurred when being moved through the path may be superimposed on an analog signal outputted from the coil 34. However, when the card reader includes the magnetic head 6 in this embodiment, noise can be removed from a signal outputted from the magnetic head 6. Therefore, reading accuracy for the magnetic track 11 by the card reader is improved.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A magnetic head comprising:
a head main body comprising a core provided with a gap and a coil which is wound around the core;
a demodulation circuit structured to demodulate an analog signal outputted from the coil;
an encryption circuit structured to encrypt a demodulated signal outputted from the demodulation circuit; and
a head case in which the head main body is accommodated;
the magnetic head being structured so that a change of a magnetic field when a magnetic recording medium is passed through the gap is detected;
wherein the magnetic head further comprises a filter circuit which is connected between the coil and the demodulation circuit and is structured to remove noise from the analog signal; and
wherein an electronic component which structures the filter circuit is accommodated in the head case.

2. The magnetic head according to claim 1, further comprising a circuit board comprising a wiring pattern for the filter circuit and on which the electronic component is mounted,
wherein the circuit board is accommodated in the head case.

3. The magnetic head according to claim 2, wherein
the head main body comprises a first terminal which is connected with one end of the coil and a second terminal which is connected with an other end of the coil and is extended in parallel to and separated from the first terminal, and
the circuit board is laid across the first terminal and the second terminal.

4. The magnetic head according to claim 3, wherein
the head main body comprises a plurality of the head main bodies which are arranged in a direction intersecting a passing direction in which the magnetic recording medium is passed,
the circuit board comprises a plurality of the circuit boards each of which is laid across the first terminal and the second terminal of each of the head main bodies, and
a shield plate is inserted between the head main bodies adjacent to each other.

5. The magnetic head according to claim 4, wherein resin is filled in an inside of the head case.

6. The magnetic head according to claim 1, further comprising a second circuit board which comprises the demodulation circuit on one circuit board face and the encryption circuit on an other circuit board face,
wherein the head case comprises an opening part for inserting the head main body into the head case,
wherein the second circuit board is fixed to the head case so that the opening part is closed in a state that the one circuit board face is directed toward a side of the head case, and
wherein the demodulation circuit is disposed in an inside of the head case.

7. A card reader comprising:
a magnetic head comprising:
a head main body comprising a core provided with a gap and a coil which is wound around the core;
a demodulation circuit structured to demodulate an analog signal outputted from the coil;
an encryption circuit structured to encrypt a demodulated signal outputted from the demodulation circuit; and
a head case in which the head main body is accommodated; and
a path where a magnetic card comprising a magnetic track is moved so as to pass the gap of the magnetic head,
wherein the magnetic head comprises a filter circuit which is connected between the coil and the demodulation circuit and is structured to remove noise from the analog signal, and
wherein an electronic component structuring the filter circuit is accommodated in the head case.

8. The magnetic head according to claim 2, further comprising a second circuit board which comprises the demodulation circuit on one circuit board face and the encryption circuit on an other circuit board face,
wherein the head case comprises an opening part for inserting the head main body into the head case,
wherein the second circuit board is fixed to the head case so that the opening part is closed in a state that the one circuit board face is directed toward a side of the head case, and
wherein the demodulation circuit is disposed in an inside of the head case.

9. The magnetic head according to claim 3, further comprising a second circuit board which comprises the demodulation circuit on one circuit board face and the encryption circuit on an other circuit board face,
wherein the head case comprises an opening part for inserting the head main body into the head case,
wherein the second circuit board is fixed to the head case so that the opening part is closed in a state that the one circuit board face is directed toward a side of the head case, and
wherein the demodulation circuit is disposed in an inside of the head case.

10. The magnetic head according to claim 4, further comprising a second circuit board which comprises the demodulation circuit on one circuit board face and the encryption circuit on an other circuit board face,
wherein the head case comprises an opening part for inserting the head main body into the head case,
wherein the second circuit board is fixed to the head case so that the opening part is closed in a state that the one circuit board face is directed toward a side of the head case, and
wherein the demodulation circuit is disposed in an inside of the head case.
